(19) United States
(12) Patent Application Publication
(10) Pub. No.: US 2007/0290380 A1
(43) Pub. Date: Dec. 20, 2007

(54) Device for Injecting Gas Into a Liquid

(76) Inventors: Pierre Avrillier, Paris (FR); Catherine Xuereb, Pechabou (FR); Martine Poux, Toulouse (FR); Rodolphe Sardeing, Toulouse (FR)

Correspondence Address: AIR LIQUIDE;Intellectual Property, 2700 POST OAK BOULEVARD, SUITE 1800, HOUSTON, TX, 77056, US

(21) Appl. No.: 10/599,573

(22) PCT Filed: Mar. 23, 2005
(86) PCT No.: PCT/FR05/50184

§ 371 Date: Jun. 6, 2007

(30) Foreign Application Priority Data
Apr. 2, 2004 (FR) 0450660

(51) Int. Cl. B01F 3/04

(52) U.S. Cl. 261/87

(57) ABSTRACT

The invention concerns a device for stirring a liquid (L) in a reactor and for injecting a gas in said liquid, comprising a self-aspirating turbine (5) for producing a gas-liquid dispersion, an axial flow rotor (4) with axial flow for collecting said dispersion, and means for directing the gas-liquid dispersion towards said axial flow rotor (4) with axial flow. The invention is characterized in that said means comprise deflecting means (8) integrated in the self-aspirating turbine (5). The invention is applicable to the biological treatment of industrial effluents.

The present invention relates to a device for injecting a gas into a liquid.

The invention has a particularly advantageous application in the field of the biological treatment of industrial effluents.

The gas injected into the liquid may be an oxygenated gas with a proportion of oxygen of between 20 and 100%, carbon dioxide, an ozonated gas, or a biogas. The liquid into which the gas is injected is placed in reactors used particularly for the biological treatment of industrial effluents, generally varying between 2 and 10 meters in height.

In the description below, the term “reactor” means natural “basin” (lagoon, pond, lake, etc.) and also “reservoir” with walls more or less close to one another and open-air or roofed.

The reactors in which the gas injection systems serve to inject gases generally contain activated sludge. These reactors can therefore either be natural basins, open-air reactors with walls close to one another, or closed reactors, pressurized or not.

In the field of biological wastewater treatment, various types of device are known, according to whether the gas is injected at the surface or at the bottom of the basin. Examples include surface turbines, and brushes for transferring air into the liquid by creating a stirring effect. Such devices can only be used for low water heights and have limited oxygenation capacity.

Thus, European patent No. 0 583 509 describes a system mainly characterized by a propeller located in a hollow shaft and, during its rotation and by vortex effect, driving gas and liquid located under an immersed cover from the liquid surface. The gas-liquid mixture thus formed is propelled downward. The undissolved gas bubbles rise in a radius of action roughly corresponding to that of the cover, where they are recovered and again reinjected. The addition of make-up gas and the purge, as well as the optimal liquid level in the cover, are controlled by the pressure prevailing under the cover.

Although the announced transfer efficiencies are very good, this system has the following main limits:
the action zone limited to a radius close to that of the cover and to a relatively low water depth;
the enrichment of the gas phase with CO₂, N₂ and other gases produced by biological activity, in the case of applications with activated sludge, and the need for purges giving rise to O₂ losses;
the complexity of regulating the pressure under the cover; and
the use of a high-pressure gas: the need to use a gas compressor after a VSA or MPSA (vacuum swing adsorption or medium pressure swing adsorption production unit).

European patent application No. 0 995 485 in the name of the applicant also teaches a device for stirring a liquid in a reactor and for injecting a gas into this liquid, comprising a drive motor placed above the reactor and provided with a vertical drive shaft. One end of this drive shaft is equipped with an axial flow rotor, such as a propeller. Above the axial flow rotor, the drive shaft of the drive motor also carries a auto-suction turbine immersed in the reactor, and which can be driven by the drive shaft at the same time as the axial flow rotor.

The drive shaft is coaxially enveloped by a cylinder connected at its upper end to the drive device and of which the lower end terminates in the turbine. In the upper end of the cylinder, an opening is provided for injecting a gas into an annular interval bounded by the shaft and the cylinder. The rotation of the turbine causes suction of the gas through the hollow cylinder enveloping the drive shaft of the drive device. The turbine also permits suction of the liquid through an annular space placed between the turbine and the cylinder, thereby creating a gas-liquid dispersion with the gas. This turbine propels the gas-liquid dispersion radially.

This known device further comprises means for sending the gas-liquid dispersion expelled radially by the turbine toward the propeller. These means essentially comprise an annular box forming a deflector, enveloping the turbine and profiled in order to send the stream issuing radially from the turbine toward the propeller, and a set of substantially vertical plates forming counterblades, arranged radially and fixed to the deflector. The deflector which envelops the turbine directs the gas-liquid dispersion toward the propeller which propels the gas bubbles toward the bottom, and creates a liquid pumping flow for stirring the basin. The counterblades serve to direct the various liquid and gas streams in order to maximize the transfer and stirring efficiency.

Although it is suitable for effectively transferring a gas into a liquid and for obtaining a stirring effect for placing and maintaining particles in suspension, the device described with reference to European patent application No. 0 995 485 nevertheless has the following drawbacks:
low oxygenation capacity. The gas suction capacity is in fact limited by the flooding of the deflector box/turbine assembly. The flooding is mainly due to the deflector, which does not permit satisfactory removal of the two-phase mixture above a certain gas/liquid ratio,
unstable operation because in order to use the device optimally, it functions at a flow rate close to flooding. Costly safety elements must be added to detect the undesirable initiation of the flooding and to reprime the device,
high production cost.

Thus the technical problem to be solved by the object of the present invention is to propose a device for injecting a gas into a liquid, comprising a auto-suction turbine for producing a gas-liquid dispersion, an axial flow rotor for collecting said dispersion, and means for sending the gas-liquid dispersion to said axial flow rotor, which would offer better oxygenation capacity, as well as limited flooding, at minimum cost.

The solution to the technical problem posed, according to the present invention, consists in that said means comprise deflecting means incorporated in the auto-suction turbine.

Thus, the deflection function of the device of the invention is performed by the turbine alone. It is therefore unnecessary to rely on additional members, such as the deflecting box of European patent application No. 0 995 485. This provides the following advantages:
increase in gas suction capacity and hence in suction capacity of the device;
prevention of the flooding corresponding to the actual flooding of the turbine, obtaining operating stability in the usual flow ranges; and
reduction in the cost of the device.
   According to the invention, said deflecting means consist of an upper member, called deflecting member, of the auto-suction turbine, having a larger diameter than that of a lower member of said turbine and a profile suitable for deflecting said dispersion toward the axial flow rotor.

It is thus clear that one feature of the invention is to use a turbine which, unlike the turbines commonly used, has upper and lower members which are not parallel nor of the same diameter.

The description below, with reference to the drawings appended hereto, provided as nonlimiting examples, shows clearly the features of the invention and how it can be used.

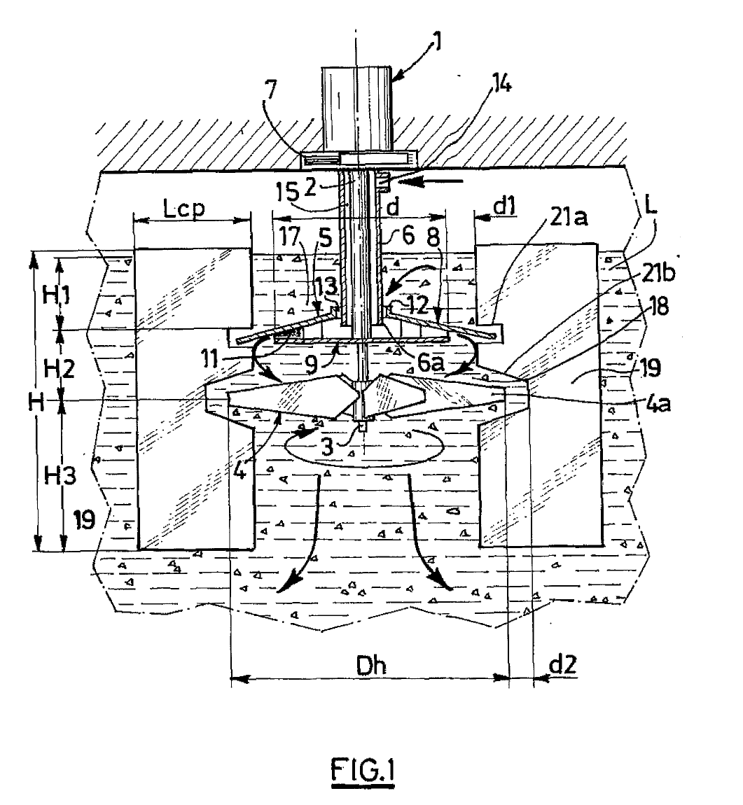

FIG. 1 is a cross section of a first embodiment of a device for injecting gas into a liquid according to the invention.

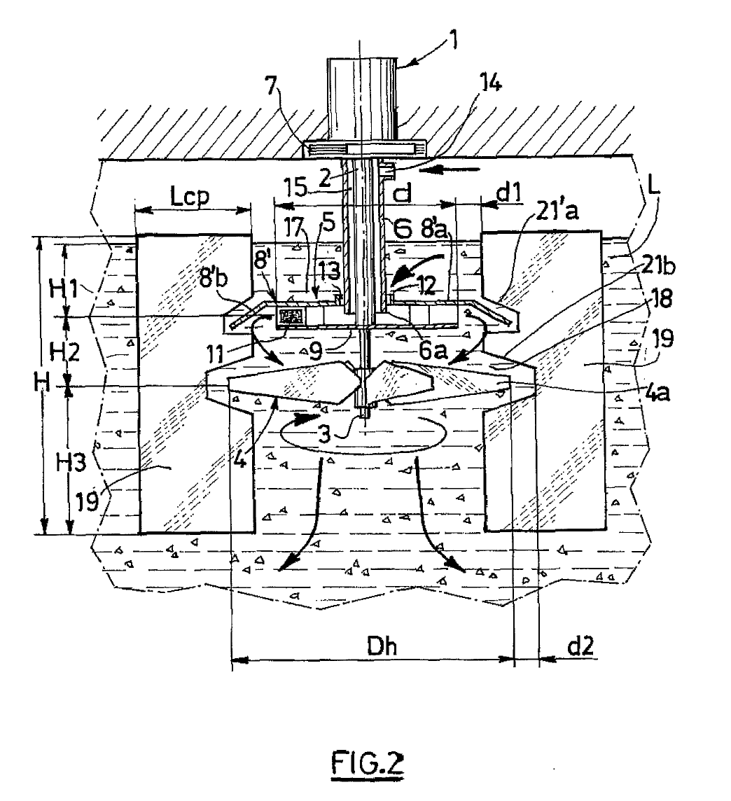

FIG. 2 is a cross section of a second embodiment of a device for injecting gas into a liquid according to the invention.

FIG. 3 is a semi-side view of an upper member of a turbine of variant embodiment of the device in FIG. 2.

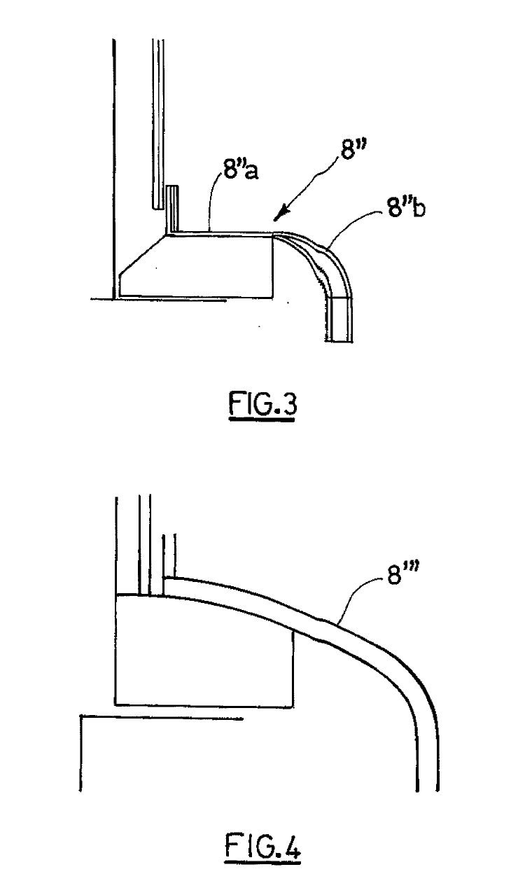

FIG. 4 is a semi-side view of an upper member of a turbine of a third embodiment of a device according to the invention.

The device shown in FIGS. 1 and 2 is designed for injecting a gas into a liquid L, this gas preferably, but not exclusively, being oxygen.

This device comprises drive means 1, for example a motor, placed above the surface of the liquid L, and provided with a rotating drive shaft 2 extending vertically and partially immersed into the liquid L. The drive shaft 2 is equipped at its lower end 3 with an axial flow rotor 4, here a propeller immersed in the liquid L. The shaft 2 also carries, placed between the propeller 4 and the surface of the liquid L, a auto-suction turbine 5 which is consequently immersed in the reactor and can be driven by the drive shaft 2 at the same speed as the propeller 4. The drive shaft 2 is coaxially enveloped by a cylinder 6 connected at its upper end to the drive means 1, with the insertion of a sealing device 7 known per se, and its lower end 6a terminates in the turbine 5 coaxially with the shaft 2.

An opening 14 is provided in the upper end of the cylinder 6, for injecting a gas into the annular interval 15 bounded by the shaft 2 and the cylinder 6. The system for injecting gas into the orifice 14 is known per se and not shown.

The auto-suction turbine 5 consists, on the one hand, of two superimposed members, that is, an upper member 8, 8′ and a lower member 9 in the form of a disk, placed horizontally and, on the other, a set of radial blades 11 placed between the upper 8, 8′ and lower 9 members and fixed thereto. In the upper member 8, 8′ is arranged a central hole 12 bounded by a projecting collar, into which the lower end 6a of the cylinder 6 penetrates, thereby bounding an annular space 13 with the edge of said hole 12.

The drive shaft 2 passes axially through the members 8, 8′ and 9, being fixed to the lower disk 9, so that when the drive motor 1 is activated, the shaft 2 rotates the turbine 5 and the propeller 4 at the same speed. The rotation of the turbine 5 causes suction of the gas entering through the orifice 14, via the cylinder 6, and suction of part of the liquid which is introduced through the annular interval 13 left free between the turbine 5 and the cylinder 6. This gas-liquid dispersion results in a population of bubbles, the majority of which are between 100 microns and 2 mm in size.

The device in FIGS. 1 and 2 also comprises means for sending the gas-liquid dispersion expelled radially by the turbine 5 between its blades 11 toward the propeller 4.

In the embodiments described, these means comprise deflecting means incorporated in the turbine 5 itself, and consisting of the upper member 8, 8′, called the deflecting member, which has a diameter larger than that of the lower disk 9 and a profile suitable for deflecting the gas-liquid dispersion toward the axial flow rotor 4.

In the example in FIG. 1, the deflecting member 8 has a roof-shaped conical profile. Advantageously, the conical profile makes an angle of between 30° and 40° with the horizontal plane.

In the example in FIG. 2, the deflecting member 8′ comprises a horizontal-disk shaped section 8′a and a frustoconical-shaped annular flap 8′b. In the case in FIG. 3, the annular flap 8″b has a rounded profile, the central section 8″a of the deflecting member 8″ having the shape of a horizontal disk, as in FIG. 2.

FIG. 4 shows a deflecting member 8′″ with a convex profile, more specifically an elliptical profile.

The means for sending the gas-liquid dispersion toward the propeller 4 also comprise a set of substantially vertical plates 19, forming counterblades, arranged radially around the turbine 5 and the propeller 4 in an appropriate number at predefined angular intervals.

In the inner edge of each counterblade 19, at the turbine 5, an upper notch 21a is arranged, into which the deflecting member 8, 8′ can penetrate, and, at the propeller 4, a lower notch 21b into which the ends of the blades of the propeller 4 can penetrate.

The counterblades 19 extend vertically from a level substantially corresponding to that of the liquid L, over a total height H of between 0.7 times and 12 times the diameter d of the turbine 5.

The device for injecting gas into a liquid described above operates as follows.

Once the drive means 1 are set in motion, the drive shaft 2 rotates the auto-suction turbine 5 and the terminal propeller 4 at the same speed. The gas is injected or sucked through the opening 14 into the annular interval 15 from which it is sucked toward the turbine 5, similarly to part of the liquid L in the annular interval 13 between the upper member 8, 8′ and the cylinder 6 (as shown by the arrow in FIG. 1). At least 90% of the dispersion of bubbles is collected due to the presence of the counterblades 19 and of the deflecting member 8, 8′ which sends the stream toward the propeller 4, as shown by the two side arrows in FIGS. 1 and 2. The propeller 4, consisting of at least two blades 4a, propels the bubble dispersion at a speed of, for example, between 1 and 5 m/second toward the bottom the basin. The dimensioning and the operating conditions applied are designed to propel the bubbles to a depth of 10 meters while preserving a sufficient horizontal speed at the raft (i.e. higher than 0.1 m/s) to prevent or avoid the formation of zones of deposits or solid particles at the bottom of the basin.

The bubbles projected to the bottom of the basin then rise at the periphery of the assembly (4, 5) around the central axis 2. The travel time of the gas bubbles in the liquid is sufficient for transferring the oxygen from the gas phase (if the gas injected is oxygenated) to the liquid phase. The oxygen can then be used for the respiration needs of the biomass or the oxidation of certain compounds.

The pumping flow generated by the presence of the collecting propeller 4 and the counterblades 19 is suitable for mixing the liquid volume in a radius which depends on the power consumed by the propeller 4 (between 40 and 90% of the power applied to the drive shaft 2). This mixing places the sludge and/or solid particles in suspension in order to homogenize the concentration of sludge and/or particles in the overall volumes stirred by the propeller 4.

When the gas injected via the orifice 14 is oxygenated, the device described above is suitable for the biological treatment of industrial or municipal effluents, by transferring the oxygen to the activated sludge and by stirring the biomass in order to homogenize the sludge concentration. The deflecting member 8, 8′ which envelops the turbine 5 directs the gas-liquid dispersion toward the propeller 4 which propels the gas bubbles toward the bottom of the reactor, and creates a liquid pumping flow for stirring the reactor. The counterblades 19 serve to direct the various liquid and gas streams in order to maximize the transfer and stirring efficiency.

1-12. (canceled)

13: A device for injecting a gas into a liquid, comprising an auto-suction turbine for producing a gas-liquid dispersion, an axial flow rotor for collecting said dispersion, and means for sending the gas-liquid dispersion to said axial flow rotor, wherein said means comprise deflecting means incorporated in the auto-suction turbine.

14: The device of claim 13, wherein said deflecting means consist of an upper member, called deflecting member, of the auto-suction turbine, having a larger diameter than that of a lower member of said turbine and a profile suitable for deflecting said dispersion toward the axial flow rotor.

15: The device of claim 14, wherein said deflecting member has a conical profile.

16: The device of claim 15, wherein said conical profile makes an angle of between 30° and 40° with the horizontal plane.

17: The device of claim 14, wherein said deflecting member comprises an annular flap.

18: The device of claim 17, wherein said annular flap has a frustoconical profile.

19: The device of claim 17, wherein said annular flap has a rounded profile.

20: The device of claim 14, wherein said deflecting member is a member with a convex profile.

21: The device of claim 20, wherein said convex profile is an elliptical profile.

22: The device of claim 13, wherein the means for sending the gas-liquid dispersion to said axial flow rotor further comprise substantially vertical counterblades, arranged radially to the auto-suction turbine and to the axial flow rotor.

23: The device of claim 22, wherein the counterblades have upper notches designed to enable the deflecting member of the auto-suction turbine to penetrate therein.

24: The device of claim 22, wherein the counterblades have lower notches designed to enable the axial flow rotor to penetrate therein.
